(19) United States
(12) Patent Application Publication
(10) Pub. No.: US 2015/0288729 A1
(43) Pub. Date: Oct. 8, 2015

(54) METHOD AND SYSTEM FOR PLAYING VIDEO MEDIA FILE OF VIDEO SHARING WEBSITE IN AREA NETWORK

(71) Applicant: Primax Electronics Ltd., Taipei (TW)

(72) Inventor: JUNG-CHANG YANG, Taipei (TW)

(21) Appl. No.: 14/452,079

(22) Filed: Aug. 5, 2014

(30) Foreign Application Priority Data
Apr. 3, 2014 (TW) 103112569

(51) Int. Cl. H04L 29/06; H04L 29/08

(52) U.S. Cl. CPC H04L 65/4069; H04L 67/02

(57) ABSTRACT

A video media playing method for playing video media files of a video sharing website in an area network is provided. Firstly, a digital media server logins into the video sharing website. Moreover, plural video item data and plural video media data corresponding to the video sharing website are previously stored in the digital media server. Then, an active control device is connected to the digital media server, so that the video names of the plural video media data may be viewed by the user. When one of the plural video names is selected, the video media file corresponding to the selected video media is transmitted from the video sharing website to the area network. Consequently, the video media file is played by the active control device.

### FIELD OF THE INVENTION

The present invention relates to a video media playing method, and more particularly to a video media playing method for playing video media files in an area network.

### BACKGROUND OF THE INVENTION

Generally, an area network comprises a local area network (LAN), a metropolitan area network (MAN) and a wide area network (WAN). With increasing development of science and technology, the area network further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored into the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 may be played by the digital media renderer 33.

As mentioned above, the digital media server, the digital media controller, the digital media renderer and the digital media player included in the same DLNA system may transfer or play media files through the network router. The digital media server and the digital media renderer may be referred as passive control devices that can be controlled. Moreover, the digital media controller and the digital media player may be referred as active control devices that can control the passive control devices. For example, a user in a living room may allow a smart phone to be connected to a computer host in a study room. Moreover, through the smart phone, the user may browse the audio files in the computer host and select a desired audio file from the computer host. Then, the selected audio file is transmitted from the smart phone to a stereo device in the living room. After the audio file is received by the stereo set, the audio file is played by the stereo device. Consequently, the purposes of conveniently and quickly sharing media contents can be achieved by the DLNA system.

Recently, video sharing websites are gradually popular to most users. For example, YouTube, Tudou and Sohuthe are some of the popular video sharing websites. Through the video sharing websites, video media files may be shared among different users. For example, users may upload video media files to the video sharing websites to share the video media files. Consequently, the purpose of sharing information is achieved. Especially, the movie studios and the record companies often upload movie trailers or singers' music videos to the video sharing websites in order to enhance the visibility and achieve the advertisement effect. However, the functions of the video sharing websites cannot be conveniently applied to the DLNA system. Generally, only the digital media player is able to be connected to the video sharing website. After the digital media player is connected to the video sharing website, the video media files that are shared in the video sharing website may be browsed by the user of the digital media player. However, the video media files fail to be viewed by many users simultaneously.

In the DLNA system, the digital media renderer has a network connection function. For example, some video sharing websites (e.g. YouTube) can be browsed through a television with the network connection function. Generally, the remote controller of the digital media renderer only comprises five keys (i.e. an upper arrow key, a down arrow key, a left arrow key, a right arrow key and an Enter key), but the remote controller does not comprise the keys of input characters. Consequently, the user has to operate these five keys of the remote controller to select a character selection interface shown on the digital media renderer in order to input a search keyword into a search bar of a video sharing website. For example, if the user wants to search the video media file “Bruno Mars”, the user has to input the keyword “Bruno Mars” into the search bar of the video sharing website. That is, the following steps will be performed. Firstly, the digital media renderer is connected to the video sharing website through network connection. Then, the letters “b”, “r”, “u”, “n”, “m”, “a”, “r” and “s” are sequentially selected through the character selection interface. Then, the search result from the video sharing website is acquired. Afterwards, the video media file to be viewed is selected according to the search result. In other words, the method of operating the digital media renderer to browse the video sharing website needs the complicated step of selecting letters. For most users, the above operating method is inconvenient and troublesome.

Therefore, there is a need of providing a video media playing system and a video media playing method for playing video media files of a video sharing website in an area network.

### SUMMARY OF THE INVENTION

An object of the present invention provides a video media playing method for playing video media files of a video sharing website in an area network.

Another object of the present invention provides a video media playing system for implementing the video media playing method.

In accordance with an aspect of the present invention, there is provided a video media playing method for playing video media files of a video sharing website in an area network. The video media playing method includes the following steps. Firstly, a first electronic device of the area network logins into the video sharing website according to an account and a password corresponding to the video sharing website. A virtual folder is previously stored in the first electronic device. The video sharing website contains plural video items. Each of the plural video items contains plural video media files. Then, the virtual folder is displayed on a second electronic device of the area network, and the virtual folder is selected. When the virtual folder is selected, the first electronic device retrieves plural video item data corresponding to the plural video items from the video sharing website and transmits the plural video item data to the second electronic device. The plural video item data contain plural item names and are displayed on the second electronic device. Then, one of the plural item names which are displayed on the second electronic device is selected. When the item name is selected, the first electronic device retrieves plural video media data corresponding to the selected item name from the video sharing website and transmits the plural video media data to the second electronic device. The plural video media data correspond to plural video media files in the video item with the selected item name. In addition, plural video names of the plural video media files are displayed on the second electronic device. Then, one of the plural video names which are displayed on the second electronic device is selected. When the video name is selected, the video media file corresponding to the selected video name is transmitted from the video sharing website to the second electronic device or a third electronic device of the area network, so that the video media file is played by the second electronic device or the third electronic device.

In accordance with another aspect of the present invention, there is provided a video media playing method for playing video media files of a video sharing website in an area network. The video media playing method includes the following steps. Firstly, a first electronic device of the area network logins into the video sharing website according to an account and a password corresponding to the video sharing website. The video sharing website contains plural video items. Each of the plural video items contains plural video media files. After the first electronic device logins into the video sharing website, the first electronic device retrieves plural video item data corresponding to the plural video items and plural video media data corresponding to the plural video media files from the video sharing website. The plural video item data contain plural item names corresponding to the plural video items. In addition, each of the plural video media data contains plural video names corresponding to the plural video media files. Then, plural video item data and the plural video media data are stored into the first electronic device, and the video sharing website is correlated with a virtual folder of the first electronic device. Then, the virtual folder is displayed on a second electronic device of the area network, and the virtual folder is selected. When the virtual folder is selected, the plural video item data corresponding to the plural video items are transmitted from the first electronic device to the second electronic device. The plural video item data contain plural item names and are displayed on the second electronic device. Then, one of the plural item names which are displayed on the second electronic device is selected. When the item name is selected, the first electronic device retrieves the plural video media data corresponding to the selected item name from the video sharing website and transmits the plural video media data to the second electronic device. The plural video media data correspond to the plural video media files in the video item with the selected item name. The plural video names of the plural video media files are displayed on the second electronic device. Then, one of the plural video names which are displayed on the second electronic device is selected. When the video name is selected, the video media file corresponding to the selected video name is transmitted from the video sharing website to the second electronic device or a third electronic device of the area network, so that the video media file is played by the second electronic device or the third electronic device.

In accordance with a further aspect of the present invention, there is provided a video media playing system. The video media playing system includes a video sharing website and an area network. The video sharing website contains plural video items. Each of the plural video items contains plural video media files. The video sharing website outputs plural video item data corresponding to the plural video items and plural video media data corresponding to the plural video media files. Each of the plural video item data contains an item name of the corresponding video item. In addition, each of the plural video media data contains a video name of the corresponding video media file. The area network is connected to the video sharing website through network connection. The area network includes a network router, a digital media server, and an active control device. The network router is connected to the video sharing website through network connection, and provides a network connection function. The digital media server is connected to the network router through network connection and connected to the video sharing website via the network router through network connection. The digital media server logins into the video sharing website according to an account and a password corresponding to the video sharing website, or the digital media server receives the plural video item data and the plural video media data and outputs the plural video item data and the plural video media data. The active control device is connected to the network router through network connection and connected to the digital media server and the video sharing website via the network router through network connection. The plural item names and the plural video names are selective through the active control device. When one of the plural video names is selected, the active control device retrieves the video media file corresponding to the video name from the video sharing website, and the video media file is transmitted from the video sharing website to the area network, so that the video media file is acquired and played by one of the active control device and a digital media renderer of the area network.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a video media playing system according to a first embodiment of the present invention;

FIG. 5 schematically illustrates the video media architecture of the video sharing website of the video media playing system according to the first embodiment of the present invention;

FIGS. 6A˜6C schematically illustrate a flowchart of a video media playing method implemented by the video media playing system according to the first embodiment of the present invention;

FIG. 7 is a flowchart illustrating the step A of the video media playing method according to the embodiment of the present invention;

FIG. 8 schematically illustrates a login interface of the video media playing system according to the first embodiment of the present invention;

FIG. 9 is a table indicating the metadata of the video media playing system according to the embodiment of the present invention;

FIG. 10 is a schematic functional block diagram illustrating a video media playing system according to a second embodiment of the present invention;

FIG. 11 is a schematic functional block diagram illustrating a video media playing system according to a third embodiment of the present invention;

FIGS. 12A and 12B schematically illustrates a flowchart of a video media playing method implemented by the video media playing system according to the third embodiment of the present invention; and

FIG. 13 is a schematic functional block diagram illustrating a video media playing system according to a fourth embodiment of the present invention.

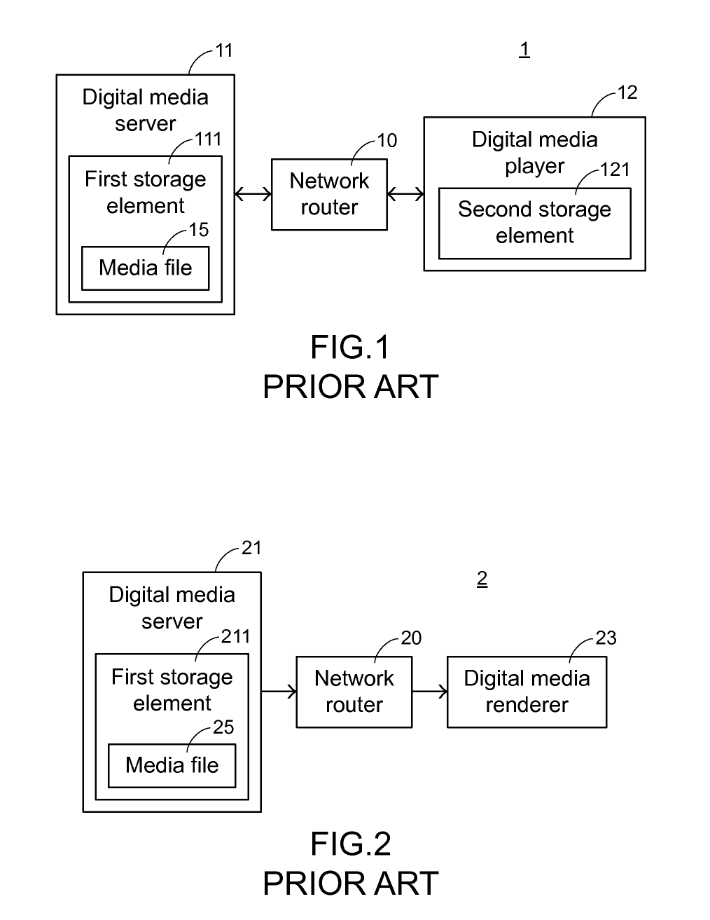

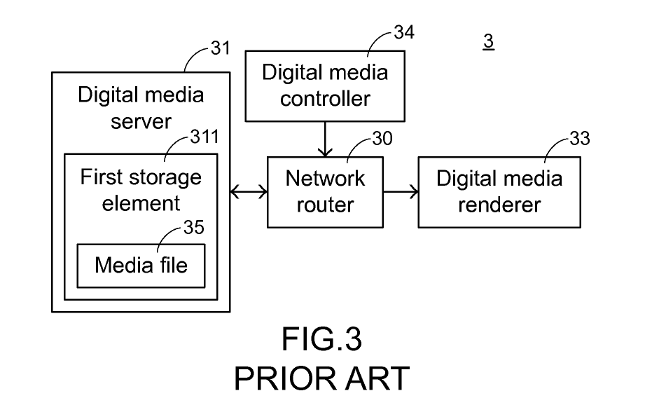

### DETAILED DESCRIPTION OF THE PREFERRED EMBODIMENT

For obviating the drawbacks of the prior art technologies, the present invention provides a video media playing method for playing video media files of a video sharing website in an area network and a video media playing system for implementing the video media playing method of the present invention.

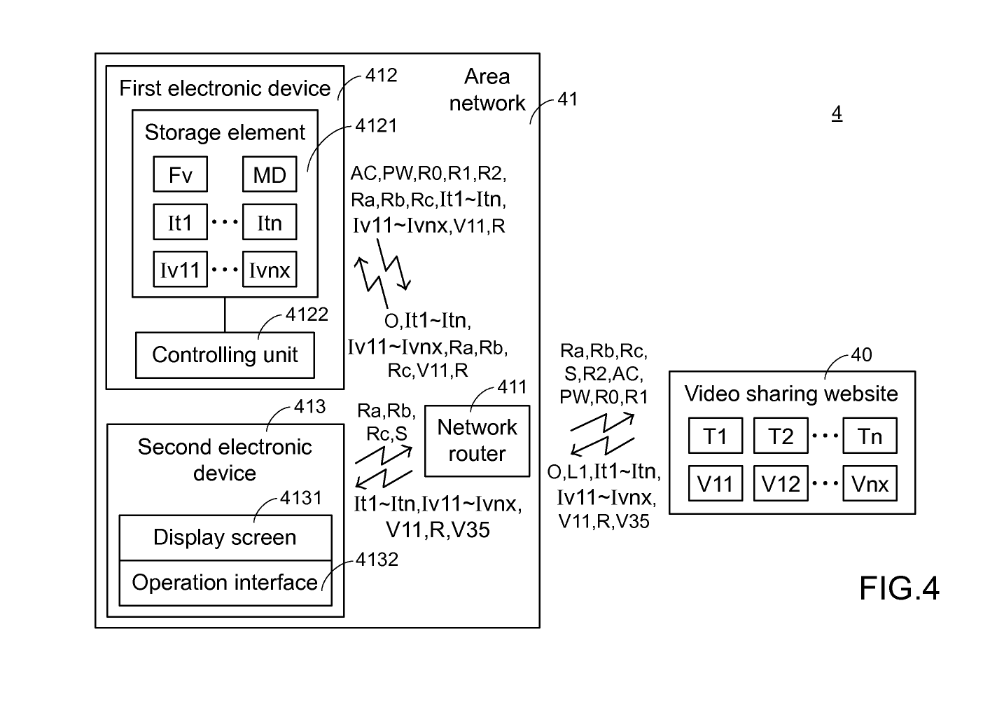

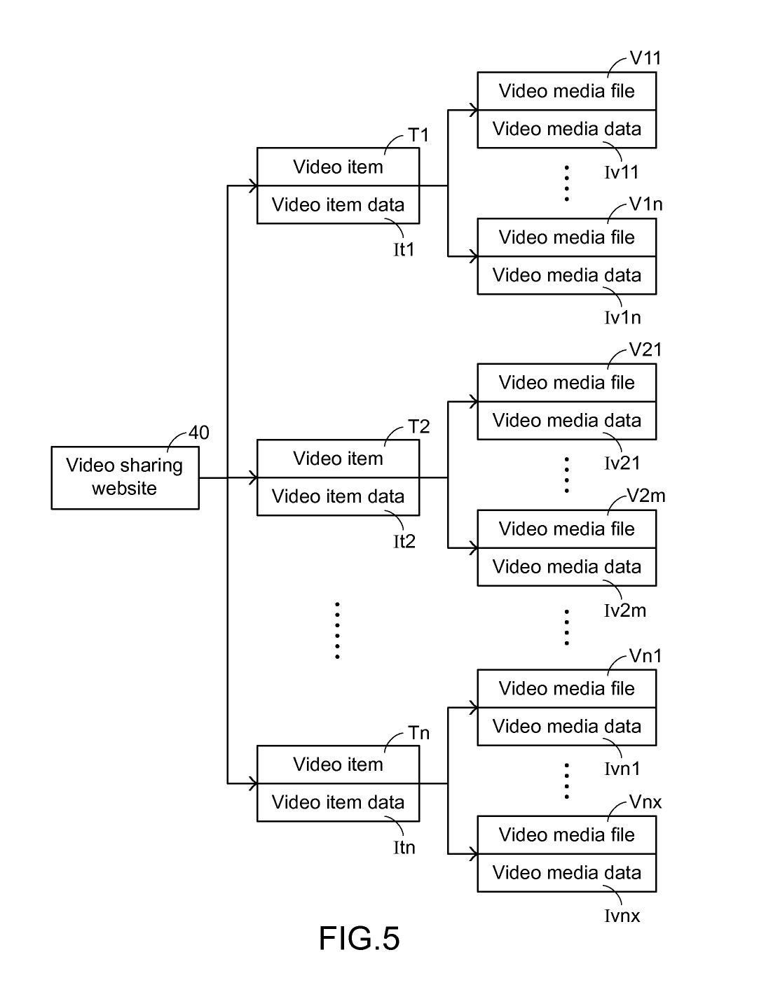

Hereinafter, a video media playing system of the present invention will be illustrated with reference to FIGS. 4 and 5. FIG. 4 is a schematic functional block diagram illustrating a video media playing system according to a first embodiment of the present invention. FIG. 5 schematically illustrates the video media architecture of the video sharing website of the video media playing system according to the first embodiment of the present invention. As shown in FIGS. 4 and 5, the video media playing system 4 comprises a video sharing website 40 and an area network 41. The video sharing website 40 contains plural video items T1˜Tn. The video item T1 contains plural video media files V11˜V1n. The video item T2 contains plural video media files V21˜V2m. The video item Tn contains plural video media files Vn1˜Vnx. The rest may be deduced by analogy. As shown in FIG. 5, the plural video items T1˜Tn and the plural video media files V11˜Vnx in the video sharing website 40 are arranged in a hierarchical architecture. The root directory of the video sharing website 40 is in the first level of the hierarchical architecture; the plural video items T1˜Tn are in the second level of the hierarchical architecture; and the plural video media files V11˜Vnx are in the third level of the hierarchical architecture. In an embodiment, the video sharing website 40 is the website “YouTube”, but is not limited thereto. In another embodiment, the video sharing website 40 is the website “Tudou” or “Sohu”.

As shown in FIG. 4, the area network 41 comprises a network router 411, a first electronic device 412, and a second electronic device 413. The network router 411 is used to provide a network connection function. The first electronic device 412 and the second electronic device 413 are connected with each other via the network router 411 through network connection. Moreover, the first electronic device 412 and the second electronic device 413 are connected to the video sharing website 40 via the network router 411 through network connection. The first electronic device 412 is connected to the network router 411 through network connection. Moreover, the first electronic device 412 is connected to the second electronic device 413 and the video sharing website 40 via the network router 411 through network connection. Consequently, the data of the plural video items T1˜Tn and the data of the plural video media files V11˜Vnx from the video sharing website 40 may be received by the first electronic device 412, and these data may be stored into the first electronic device 412. The first electronic device 412 comprises a storage element 4121 and a controlling unit 4122. The storage element 4121 is included in the first electronic device 412 for storing these data. The controlling unit 4122 is connected to the storage element 4121. The controlling unit 4122 has two functions. Firstly, the controlling unit 4122 may receive an account AC and a password PW corresponding to the video sharing website 40. According to the account AC and the password PW, the first electronic device 412 may login into the video sharing website 40. Secondly, according to these data from the video sharing website 40, a virtual folder Fv corresponding to the video sharing website 40 is created by the controlling unit 4122. The procedures of allowing the first electronic device 412 to login into the video sharing website 40 and these data provided by the video sharing website 40 will be illustrated in more details later. In this embodiment, the first electronic device 412 is a digital media server, the storage element 4121 is a hard disc, and the controlling unit 4122 is a microprocessor.

The second electronic device 413 is connected to the network router 411 through network connection. Moreover, the second electronic device 413 is connected to the first electronic device 412 and the video sharing website 40 via the network router 411 through network connection. When the second electronic device 413 is connected to the first electronic device 412 through network connection, the virtual folder Fv is displayed on the second electronic device 413, and the virtual folder Fv may be selected by the user. Consequently, the plural video items T1˜Tn of the video sharing website 40 corresponding to the virtual folder Fv and the detailed contents of these video items may be viewed by the user through the second electronic device 413. The second electronic device 413 comprises a display screen 4131 and an operation interface 4132. The virtual folder Fv and the architecture of the plural video items T1˜Tn of the video sharing website 40 may be displayed on the display screen 4131. Via the operation interface 4132, the user may operate the virtual folder Fv and the architecture of the video sharing website 40 in order to generate corresponding operation commands. In this embodiment, the second electronic device 413 is an active control device such as a digital media player (e.g. a smart phone). Moreover, the network router 411 complies with the universal plug and play (UPnP) protocol. Moreover, both of the first electronic device 412 and the second electronic device 413 comply with the Digital Living Network Alliance (DLNA) protocol.

The details contents of the data provided by the video sharing website 40 will be illustrated as follows. When the first electronic device 412 of the video media playing system 4 is connected to the video sharing website 40 through network connection, plural video item data It1˜Itn corresponding to the plural video items T1˜Tn and plural video media data Iv11˜Ivnx corresponding to the plural video media files V11˜Vnx are transmitted from the video sharing website 40 to the first electronic device 412 in response to a retrieve request from the first electronic device 412. The video media data Iv11˜Iv1n correspond to the video media files V11˜V1n of the video item T1. The video media data Iv21˜Iv2m correspond to the video media files V21˜V2m of the video item T2. The video media data Ivn1˜Ivnx correspond to the video media files Vn1˜Vnx of the video item Tn. The rest may be deduced by analogy. All of the plural video item data It1˜Itn contain corresponding item names, corresponding item identities, corresponding item kinships and corresponding item types. In addition, all of the video media data Iv11˜Ivnx contain corresponding video names, corresponding video identities, corresponding video kinships and corresponding video types.

After the plural video item data It1˜Itn and the plural video media data Iv11˜Ivnx are received by the first electronic device 412, the second electronic device 413 may be connected to the first electronic device 412 through network connection. In addition, when the plural item names contained in the plural video item data It1˜Itn are viewed by the user through the second electronic device 413, the user may realize that the plural video media files V11˜Vnx are contained in the video sharing website 40.

Moreover, after the first electronic device 412 is connected to the video sharing website 40 through network connection, the user may search a specified video media file (e.g. the video media file “Bruno Mars”) through the first electronic device 412. Consequently, the first electronic device 412 issues a search command corresponding to the video media file “Bruno Mars” to the video sharing website 40. In response to the search command from the first electronic device 412, a search result corresponding to the search command is transmitted from the video sharing website 40 to the first electronic device 412. The search result contains the video media data corresponding to plural video media files related to “Bruno Mars”. According to the video names contained in the video media data, the user may realize which video media files related to “Bruno Mars” are included in the video sharing website 40.

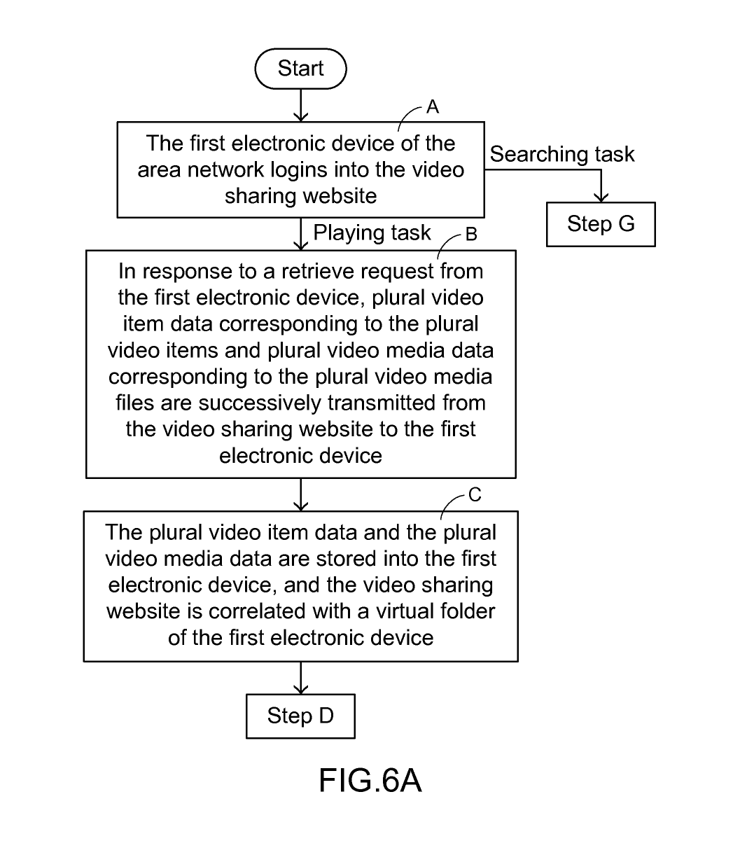

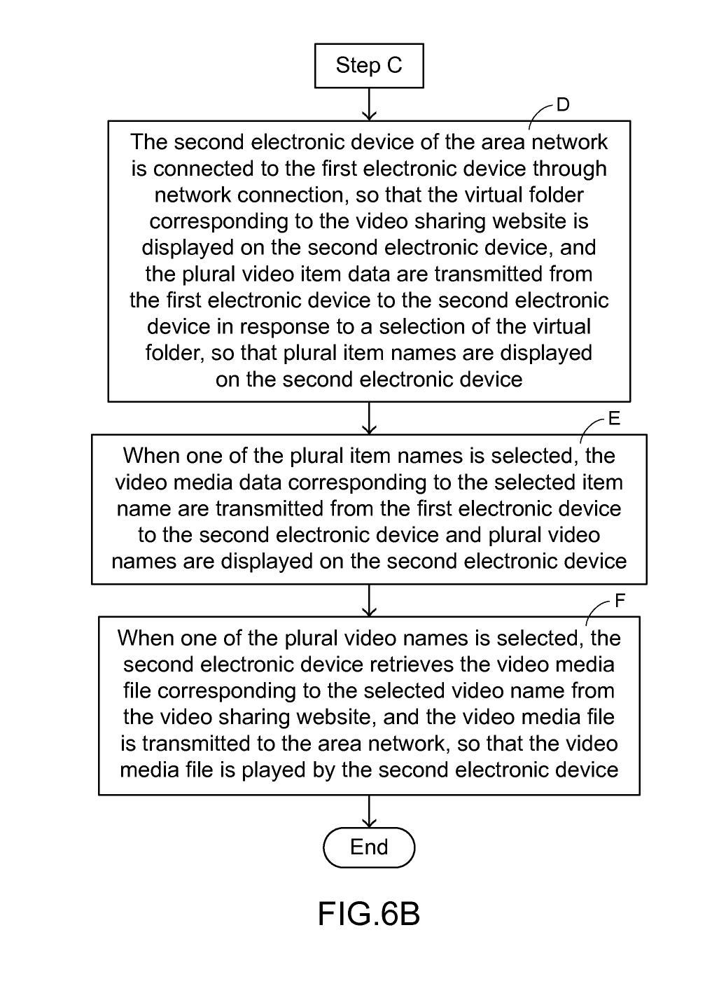

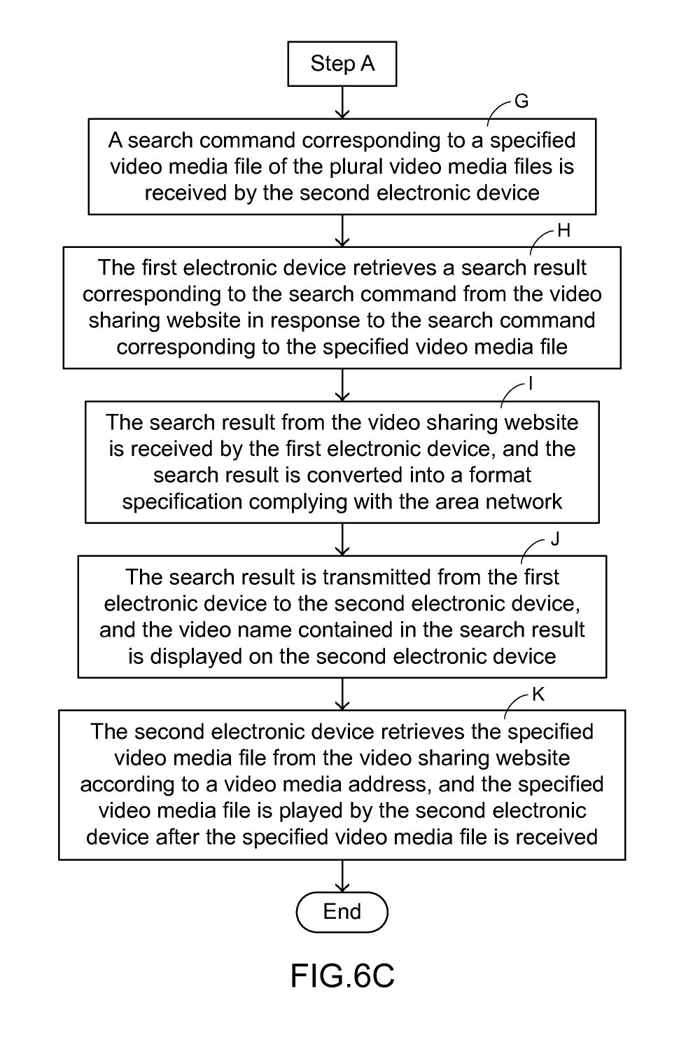

Hereinafter, a video media playing method for playing video media files of a video sharing website in an area network according to the present invention will be illustrated with reference to FIGS. 6A˜6C. FIGS. 6A˜6C schematically illustrate a flowchart of a video media playing method implemented by the video media playing system according to the first embodiment of the present invention. The video media playing method comprises the following steps.

Firstly, in a step A, the first electronic device of the area network logins into the video sharing website. In a step B, plural video item data corresponding to the plural video items and plural video media data corresponding to the plural video media files are successively transmitted from the video sharing website to the first electronic device in response to a retrieve request from the first electronic device. In a step C, the plural video item data and the plural video media data are stored into the first electronic device, and the video sharing website is correlated with a virtual folder of the first electronic device. In a step D, the second electronic device of the area network is connected to the first electronic device through network connection, so that the virtual folder corresponding to the video sharing website is displayed on the second electronic device, and the plural video item data are transmitted from the first electronic device to the second electronic device in response to a selection of the virtual folder, so that plural item names are displayed on the second electronic device. In a step E, when one of the plural item names is selected, the video media data corresponding to the selected item name are transmitted from the first electronic device to the second electronic device and plural video names are displayed on the second electronic device. In a step F, when one of the plural video names is selected, the second electronic device retrieves the video media file corresponding to the selected video name from the video sharing website, and the video media file is transmitted to the area network, so that the video media file is played by the second electronic device. In a step G, a search command corresponding to a specified video media file of the plural video media files is received by the second electronic device. In a step H, the first electronic device retrieves a search result corresponding to the search command from the video sharing website in response to the search command corresponding to the specified video media file. In a step I, the search result from the video sharing website is received by the first electronic device, and the search result is converted into a format specification complying with the area network. In a step J, the search result is transmitted from the first electronic device to the second electronic device, and the video name contained in the search result is displayed on the second electronic device. In a step K, the second electronic device retrieves the specified video media file from the video sharing website according to a video media address, and the specified video media file is played by the second electronic device after the specified video media file is received.

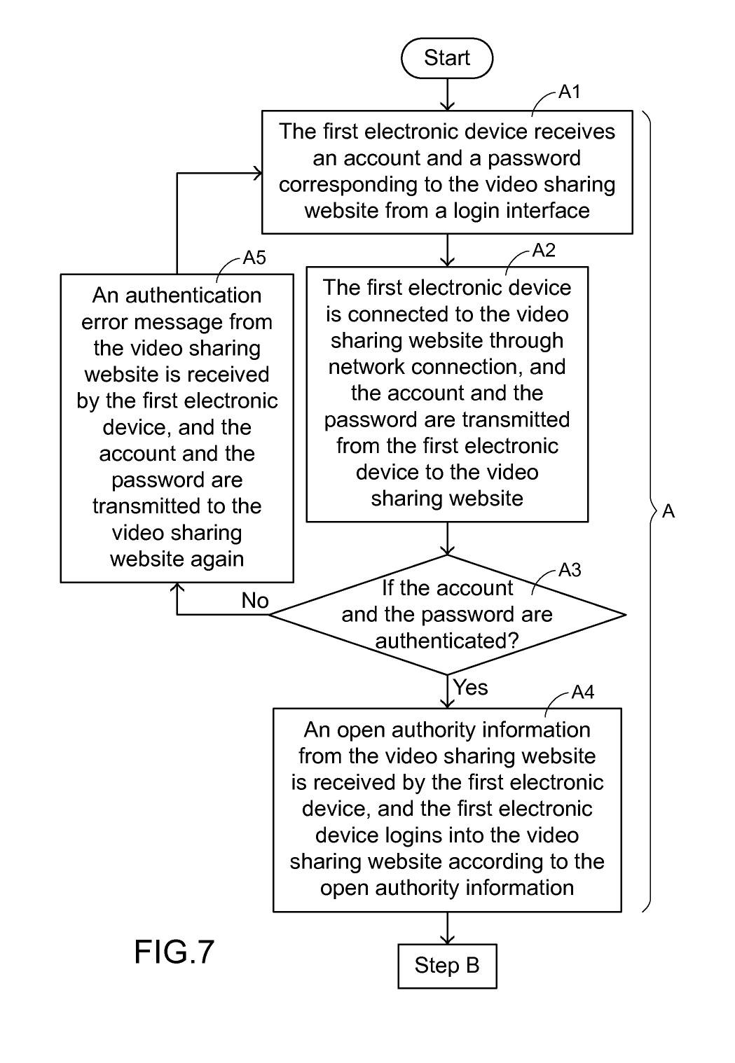

Hereinafter, the detailed procedures of the step A of the video media playing method of the present invention will be illustrated with reference to FIG. 7. FIG. 7 is a flowchart illustrating the step A of the video media playing method according to the embodiment of the present invention. The step A comprises the following sub-steps A1˜A5. In the sub-step A1, the first electronic device receives an account and a password corresponding to the video sharing website from a login interface. In the sub-step A2, the first electronic device is connected to the video sharing website through network connection, and the account and the password are transmitted from the first electronic device to the video sharing website. In the sub-step A3, the video sharing website judges whether the account and the password are authenticated or not, and an authentication result corresponding to the account and the password is transmitted from the video sharing website to the first electronic device. In the sub-step A4, if the authentication result indicates that the account and the password are authenticated, an open authority information from the video sharing website is received by the first electronic device, and the first electronic device logins into the video sharing website according to the open authority information. In the sub-step A5, if the authentication result indicates that the account and the password are not authenticated, an authentication error message from the video sharing website is received by the first electronic device, and the account and the password are transmitted to the video sharing website again.

The detailed procedures of the step C of the video media playing method of the present invention will be illustrated as follows. The step C comprises the following sub-steps C1˜C4. In the sub-step C1, plural item identities, plural item kinships and plural item types corresponding to the plural video items and plural video identities, plural video kinships and plural video types corresponding to the plural video media files are acquired by the first electronic device according to the plural video item data and the plural video media data. In the sub-step C2, the plural item identities, the plural item kinships, the plural item types, the plural video identities, the plural video kinships and the plural video types are written into a metadata corresponding to the video sharing website by the first electronic device, and the metadata is stored into the first electronic device. In the sub-step C3, a virtual folder is created in the first electronic device. In the sub-step C4, the video sharing website is correlated with the virtual folder according to the plural item identities, the plural item kinships, the plural item types, the plural video identities, the plural video kinships and the plural video types.

The metadata of the of the video sharing website describes the data property information in order to indicate the storage location, the history data, the resource search, the file record or any other appropriate information. In other words, the metadata is an electronic list for achieving a list editing function. The metadata describes the contents or the features of the video items and the video media files in order to facilitate searching the media data.

The detailed procedures of the step F of the video media playing method of the present invention will be illustrated as follows. The step F comprises the following sub-steps F1 and F2. In the sub-step F1, when the video name is selected, the second electronic device retrieves a video media file corresponding to the selected video name from the video sharing website according to a video media address corresponding to selected video name of the plural video media data. In the sub-step F2, the second electronic device receives the video media file corresponding to the selected video name from the video sharing website, and the video media file is played by the second electronic device.

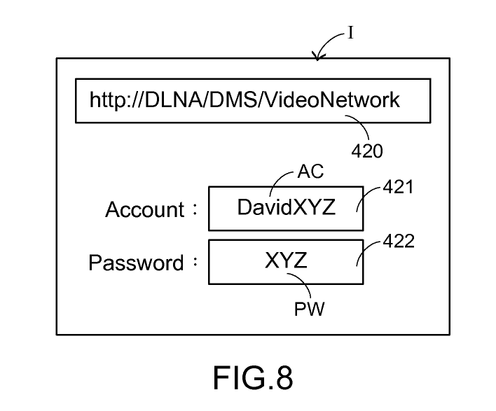

The tasks of the video media playing method of the present invention may be divided into a playing task and a searching task. Hereinafter, the detailed procedure of the playing task of the video media playing method performed by the video media playing system 4 will be illustrated with reference to FIGS. 4˜7 and FIG. 8. FIG. 8 schematically illustrates a login interface of the video media playing system according to the first embodiment of the present invention. Firstly, the user may operate a third-party device (not shown) to open the login interface I through the internet. For example, the third-party device is a computer. As shown in FIG. 8, the login interface I contains a website address bar 420, an input account field 421 and an input password field 422. By operating the third-party device to input a website address corresponding to the first electronic device 412 (e.g. http://DLNA/DMS/VideoNetwork), the third-party device is connected to the login interface I through network connection, wherein the login interface I is provided by the first electronic device 412. The website address http://DLNA/DMS/VideoNetwork is shown in the website address bar 420. Via the login interface I, the account AC may be keyed into the input account field 421, and the password PW may be keyed into the input password field 422. Consequently, the account AC and the password PW may be inputted by the user via the login interface. In addition, the account AC and the password PW are transmitted to the first electronic device 412. That is, the sub-step A1 is performed. Then, the first electronic device 412 is connected to the video sharing website 40 via the network router 411 through network connection, and the account AC and the password PW are transmitted from the first electronic device 412 to the video sharing website 40. That is, the sub-step A2 is performed.

After the account AC and the password PW are received by the video sharing website 40, the video sharing website 40 judges whether the account AC is authenticated by comparing the account AC with a predetermined account, and the video sharing website 40 judges whether the password PW is authenticated by comparing the password PW with a predetermined password. That is, the sub-step A3 is performed. If the account AC complies with the predetermined account and the password PW complies with the predetermined password, the video sharing website 40 judges that the account AC and the password PW are authenticated. Under this circumstance, an open authority information O is transmitted from the video sharing website 40 to the first electronic device 412. After the open authority information O is stored in the storage element 4121 of the first electronic device 412, the first electronic device 412 may login into the video sharing website 40 according to the open authority information O. That is, the sub-step A4 is performed. Meanwhile, the network connection between the first electronic device 412 and the video sharing website 40 is established. In the step A3, if the video sharing website 40 judges that the account AC and the password PW are not authenticated, the sub-step A5 is performed. That is, an authentication error message (not shown) is transmitted from the video sharing website 40 to the first electronic device 412 to notify the user that the account AC or the password PW is erroneously inputted. Consequently, the user may input the accurate account AC and the accurate password PW in the next time. After the sub-step A5 is completed, the sub-step A1 is performed again.

In an embodiment, the open authority information O is provided from a specified website (e.g. the video sharing website 40) to a specified electronic device. Consequently, according to the open authority information O, the user may browse the specified website through the electronic device without the need of inputting the account and the password. For example, the open authority information O is OAuth. The technical contents of OAuth are well known to those skilled in the art, and are not redundantly described herein.

After the first electronic device 412 logins into the video sharing website 40, a data retrieve request R0 is automatically transmitted from the first electronic device 412 to the video sharing website 40 through the network router 411 without the user's operation. After the data retrieve request R0 is received by the video sharing website 40, the plural video item data It1˜Itn are transmitted from the video sharing website 40 to the first electronic device 412. Consequently, according to the plural video item data It1˜Itn corresponding to the plural video items T1˜Tn, the first electronic device 412 realizes that the video sharing website 40 contains the plural video items T1˜Tn. Next, a data retrieve request R1 corresponding to the video item T1 is transmitted from the first electronic device 412 to the video sharing website 40. In response to the data retrieve request R1, the video media data Iv11˜Iv1n corresponding to the video media files V11˜V1n of the video item T1 are transmitted from the video sharing website 40 to the first electronic device 412. Consequently, the video media data Iv11˜Iv1n corresponding to the video item T1 are acquired by the first electronic device 412. Meanwhile, the procedures of acquiring the plural video item data It1˜Itn and the video media data Iv11˜Iv1n corresponding to the video item T1 by the first electronic device 412 have been mentioned above.

The procedures of acquiring the plural video item data It1˜Itn and the video media data Iv21˜Iv2m corresponding to the video item T2 by the first electronic device 412 will be illustrated as follows. A data retrieve request R2 corresponding to the video item T2 is transmitted from the first electronic device 412 to the video sharing website 40. In response to the data retrieve request R2, the video media data Iv21˜Iv2m are transmitted from the video sharing website 40 to the first electronic device 412. Consequently, the video media data Iv21˜Iv2m corresponding to the video item T2 are acquired by the first electronic device 412. In other words, after the above procedures are repeatedly done, the first electronic device 412 may acquire the plural video item data It1˜Itn and the plural video media data Iv11˜Ivnx corresponding to the video items T1˜Tn from the video sharing website 40. Meanwhile, the step B is completed.

It is noted that all of the data retrieve request R0, the data retrieve request R1 and the data retrieve request R2 comply with the format specification of the video sharing website 40. Consequently, the contents of the data retrieve requests R0, R1 and R2 can be read by the video sharing website 40, and the corresponding video item data or the corresponding video media data can be transmitted from the video sharing website 40 in response to these data retrieve requests R0, R1 and R2.

Then, the plural video item data It1˜Itn and the plural video media data Iv11˜Ivnx are stored into the storage element 4121 of the first electronic device 412. That is, the sub-step C1 is performed. Then, the plural item identities, the plural item kinships and the plural item types of the video item data It1˜Itn and the plural video identities, the plural video kinships and the plural video types of the plural video media data Iv11˜Ivnx are written into a metadata MD corresponding to the video sharing website 40 by the controlling unit 4122, and the metadata MD is stored into the storage element 4121 in order to record the arrangement of the hierarchical architecture of the video sharing website 40. That is, the sub-step C2 is performed.

It is noted that all of the plural video item data It1˜Itn and the plural video media data Iv11˜Ivnx from the video sharing website 40 comply with the format specification of the video sharing website 40. For allowing all devices of the area network to read the contents of the plural video item data It1˜Itn and the plural video media data Iv11˜Ivnx, the plural video item data It1˜Itn and the plural video media data Iv11˜Ivnx complying with the format specification of the video sharing website 40 are converted into the format specification of the area network 41 by the first electronic device 412. That is, these data can comply with the DLNA protocol in order to be read by the devices of the area network 41. Then, the plural video item data It1˜Itn and the plural video media data Iv11˜Ivnx complying with the format specification of the area network 41 are stored into the storage element 4121.

Then, a virtual folder Fv is created in the storage element 4121 by the controlling unit 4122. That is, the sub-step C3 is performed. Then, the video sharing website 40 is correlated with the virtual folder Fv according to the plural item identities, the plural item kinships, the plural item types, the plural video identities, the plural video kinships and the plural video types. That is, the sub-step C4 is performed. In this embodiment, all of the plural video item data It1˜Itn contain item type data corresponding to the video sharing website 40, and all of the plural video media data Iv11˜Ivnx contain video type data corresponding to the video sharing website 40. Consequently, according to the item type data and the video type data, the video sharing website 40 is correlated with the virtual folder Fv by the controlling unit 4122.

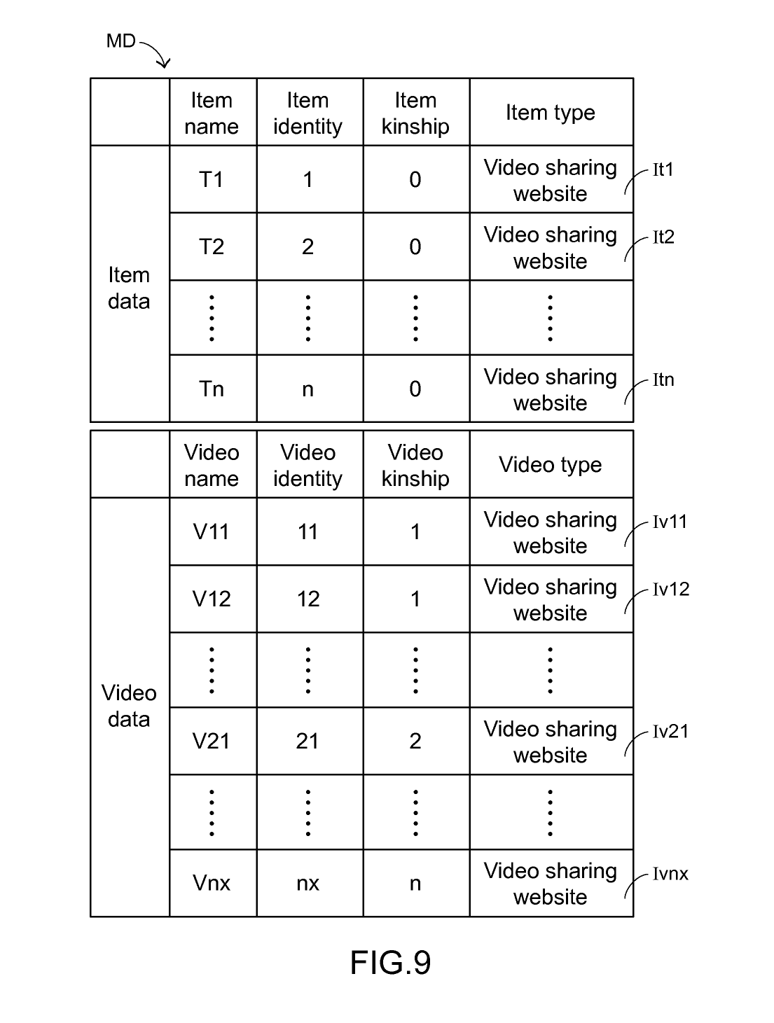

The following two aspects should be specially described. Firstly, all of the plural video item data It1˜Itn contain the corresponding item names, the corresponding item identities and the corresponding item kinships. For example, the item name corresponding to the video item data It1 is the video item T1 (e.g. My Subscription item). The item identity denotes the identification information of the video item T1 in the video sharing website 40. The item identity corresponding to the video item data It1 is 1. The item kinship corresponding to the video item data It1 is 0. Moreover, the album identity for defining the root directory of the video sharing website 40 is 0. The contents of the metadata MD are shown in FIG. 9. Similarly, the item name corresponding to the video item data It2 is the video item T2 (e.g. Watch History item). The album identity corresponding to the video item data It2 is 2, which is different from the item identity of the video item T1. The item kinship corresponding to the video item data It2 is also 0. Consequently, the video sharing website 40 is in the first level of the root directory. According to the item kinships, the video item T1 and the video item T2 are in the second level of the root directory. The rest may be deduced by analogy.

Secondly, the contents of the plural video media data Iv11˜Ivnx are similar to the contents of the plural video item data It1˜Itn. That is, all of the plural video media data Iv11˜Ivnx contain the corresponding video names, the corresponding video identities and the corresponding video kinships. For example, the video name corresponding to the video media data Iv11 is the video media file V11 (e.g. BrunoMars_MarryYou.AVI). The video identity corresponding to the video media data Iv11 is 11, which denotes the identification information of the video media data Iv11 in the video sharing website 40. The video kinship corresponding to the video media data Iv11 is 1. In other words, the video media file V11 is contained in the video item T1. Moreover, the video media file V11 is in the third level of the root directory (see FIG. 9). Consequently, according to the corresponding video identity and the corresponding video kinship, the controlling unit 4122 may realize that the video media file V11 is contained in the video item T1 and the video media file V11 is in the next level of the video item T1. According to the video identities and the video kinships corresponding to the remaining video media data Iv11˜Ivnx, the controlling unit 4122 may realize the similar results, which are not redundantly described herein. In other words, the controlling unit 4122 may store the entire hierarchical architecture of the video sharing website 40 according to the plural video item data It1˜Itn and the plural video media data Iv11˜Ivnx.

After the step C is completed, the second electronic device 413 is connected to the first electronic device 412 via the network router 411 through network connection. Consequently, the virtual folder Fv correlated with the video sharing website 40 is displayed on the display screen 4131 of the second electronic device 413. That is, the step D is performed. Then, in the step E, the virtual folder Fv is selected by the user via the operation interface 4132 of the second electronic device 413. Consequently, the second electronic device 413 issues a video item retrieve request Ra to the first electronic device 412. In response to the video item retrieve request Ra, the plural video item data It1˜Itn are transmitted from the first electronic device 412 to the second electronic device 413. Consequently, the plural video names corresponding to the plural video items T1˜Tn are displayed on the display screen 4131 of the second electronic device 413.

Please refer to FIGS. 4, 5 and 6A again. In the step E, the item name of the plural item names corresponding to the video item data It1 is selected by the user via the operation interface 4132 of the second electronic device 413. Consequently, the second electronic device 413 issues a video media retrieve request Rb corresponding to the video item data It1 to the first electronic device 412. In response to the video media retrieve request Rb, the plural video media data Iv11˜Iv1n corresponding to the video item data It1 are transmitted from the controlling unit 4122 to the second electronic device 413. The plural video media data Iv11˜Iv1n contain the video names corresponding to the video media files V11˜V1n, the media thumbnails corresponding to the video names, the video lengths corresponding to the video names, the video media addresses corresponding to the video names or any other appropriate video media data. Moreover, the plural video names or other appropriate video media data may be displayed on the display screen 4131 of the second electronic device 413. In this embodiment, the plural video names, the media thumbnails corresponding to the video names and the video lengths corresponding to the video names are displayed on the display screen 4131.

Next, in the sub-step F1, the video name corresponding to the video media data Iv11 is selected by the user via the operation interface 4132 of the second electronic device 413. According to a video media address of the video media data Iv11, the second electronic device 413 is connected to the video sharing website 40 through network connection, and the second electronic device 413 issues a video media retrieve request Rc to the video sharing website 40. In response to the video media retrieve request Rc, the video media file V11 corresponding to the video media data Iv11 is transmitted from the video sharing website 40 to the second electronic device 413, and the video media file V11 is played by the display screen 4131 of the second electronic device 413. That is, the sub-step F2 is performed. Meanwhile, the playing task of the video media playing method for playing video media files of the video sharing website in the area network is completed. The procedures of playing the video media files V21˜Vnx corresponding to the video items T2˜Tn are similar to the above procedures, and are not redundantly described herein.

Hereinafter, the detailed procedure of the searching task of the video media playing method performed by the video media playing system 4 will be illustrated with reference to FIGS. 4, 6A and 6B. After the step A is performed by the video media playing system 4, the user may search a desired video media file from the video sharing website 40. For example, if the user wants to search the video media file V35 with a video name “Just the Way You Are.AVI”, the user has to input the search keyword “Just the Way You Are” into the operation interface 4132 of the second electronic device 413. Consequently, a search command S containing the above keyword is transmitted from the second electronic device 413 to the first electronic device 412. That is, the step G is performed. The search command S corresponding to the video media file V35 complies with the format specification of the area network 41. That is, the search command S complies with the DLNA protocol. After the search command S corresponding to the video media file V35 is received by the first electronic device 412, the first electronic device 412 retrieves a search result corresponding to the search command S from the video sharing website 40 in response to the search command S. That is, the step H is performed. Consequently, after the keyword “Just the Way You Are” is searched by the video sharing website 40, the search result R is obtained. The search result R contains the video media data Iv35 corresponding to the video media file V35. In addition, the search result R complies with the format specification of the video sharing website 40. After the search result R is obtained, the search result R is transmitted from the video sharing website 40 to the first electronic device 412. In the step I, the search result R from the video sharing website 40 is received by the first electronic device 412, and the search result R is converted into a format specification complying with the area network 41. That is, the search result R complies with the DLNA protocol.

Next, in the step J, the search result R is transmitted from the first electronic device 412 to the second electronic device 413, and the video name “Just the Way You” of the video media data Iv35 that is contained in the search result R is displayed on the second electronic device 413. The video media data Iv35 also contains the video media address L35 corresponding to the video media file V35. Since the video media address L35 is contained in the video media data Iv35, the video media address L35 is not shown in the drawings. Consequently, according to the video media address L35, the second electronic device 413 retrieves the video media file V35 from the video sharing website 40. After the video media file V35 is received by the second electronic device 413, the video media file V35 is played by the second electronic device 413. That is, the step K is performed. Meanwhile, the searching task of the video media playing method of the present invention is completed. In other words, the video media file to be watched may be acquired by performing the playing task or the searching task of the video media playing method.

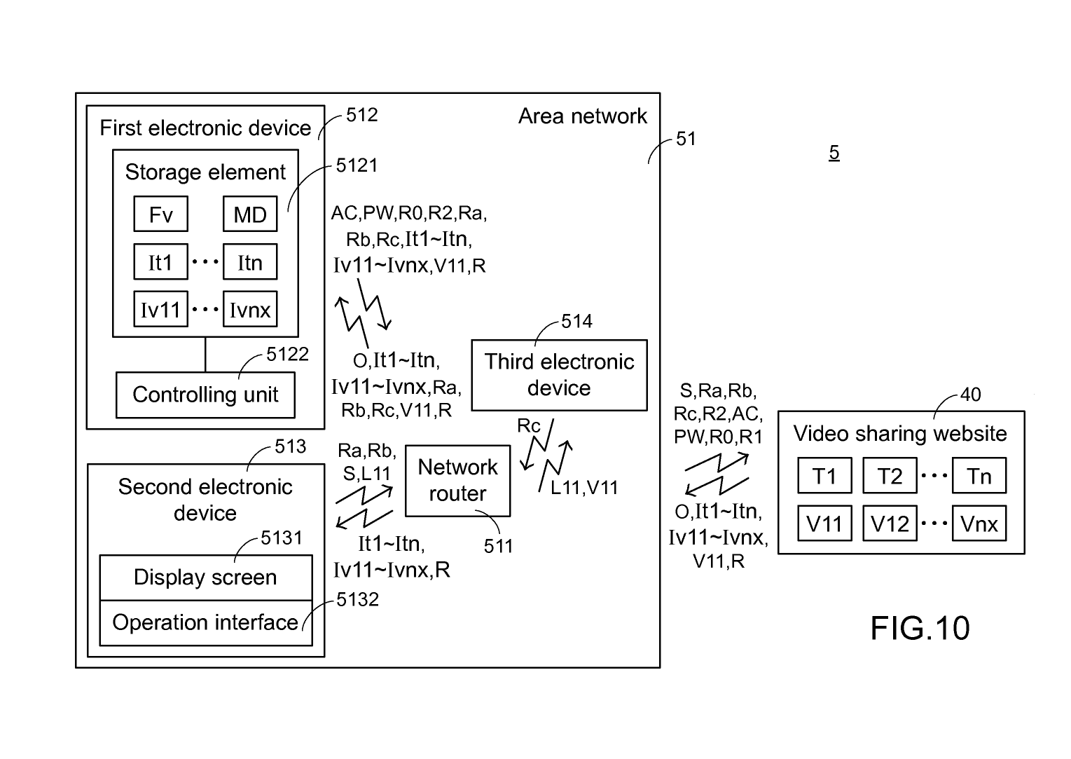

The present invention further provides a second embodiment, which is distinguished from the first embodiment. FIG. 10 is a schematic functional block diagram illustrating a video media playing system according to a second embodiment of the present invention. As shown in FIG. 10, the video media playing system 5 comprises a video sharing website 40 and an area network 51. The configurations and functions of the video sharing website 40 are identical to those of the video sharing website of the first embodiment, and are not redundantly described herein. As shown in FIG. 10, the area network 51 comprises a network router 511, a first electronic device 512, a second electronic device 513, and a third electronic device 514. The first electronic device 512 comprises a storage element 5121 and a controlling unit 5122. The second electronic device 513 comprises a display screen 5131 and an operation interface 5132. The third electronic device 514 is connected to the network router 511 through network connection. Moreover, the third electronic device 514 is connected to the second electronic device 513, the first electronic device 512 and the video sharing website 40 via the network router 511 through network connection. In this embodiment, the second electronic device 513 is an active control device such as a digital media controller (e.g. a remote controller), and the second electronic device 513 does not have the function of playing the video media files. Moreover, the third electronic device 514 is a digital media renderer (e.g. a television) for playing the video media files.

The operations of the network router 511, the first electronic device 512 and the video sharing website 40 are similar to those of the first embodiment, and are not redundantly described herein. In comparison with the first embodiment, the operations between the second electronic device 513 and the third electronic device 514 are distinguished. In other words, the steps A˜E of the video media playing method of the first embodiment are also implemented by the video media playing system 5 of this embodiment, but the step F to be implemented by the video media playing system 5 is distinguished. In the step F, when one of the plural video names is selected, the second electronic device retrieves the video media file corresponding to the selected video name from the video sharing website, and the video media file is transmitted to the area network, so that the video media file is played by the third electronic device of the area network.

The detailed procedures of the step F of this embodiment will be illustrated as follows. The step F comprises the following sub-steps F3˜F5. In the sub-step F3, a video media address corresponding to the selected video name of the plural video media data is transmitted from the second electronic device to the third electronic device. In the sub-step F4, the third electronic device retrieves the video media file corresponding to the selected video name from the video sharing website according to the video media address. In the sub-step F5, the video media file is transmitted from the video sharing website to the third electronic device, and the video media file is played by the third electronic device.

After the steps A˜E of the video media playing method of the first embodiment are implemented by the video media playing system 5, the following procedures are performed. In the sub-step F3, the video name corresponding to the video media data Iv11 is selected by the user via the operation interface 5132 of the second electronic device 513. Consequently, a video media address L11 corresponding to the video name is transmitted from the second electronic device 513 to the third electronic device 514. According to the video media address L11, a video media retrieve request Rc corresponding to the video name is transmitted from the third electronic device 514 to the video sharing website 40. That is, the sub-step F4 is performed. In response to the video media retrieve request Rc, the video media file V11 corresponding to the video media data Iv11 is transmitted from the video sharing website 40 to the third electronic device 514, and the video media file V11 is played by the third electronic device 514. That is, the sub-step F5 is performed.

By the video media playing method of this embodiment, the plural video media files V11˜Vnx of the video sharing website 40 may be collaboratively watched by the user and other users through the third electronic device 514.

The steps G˜K of the searching task of the video media playing system of this embodiment are identical to those of the first embodiment, and are not redundantly described herein. Moreover, in addition to the use of the digital media player to play the video media file, the video media playing system of the present invention may use the digital media renderer to play the video media file. Consequently, the plural video media files of the video sharing website may be collaboratively browsed by plural users.

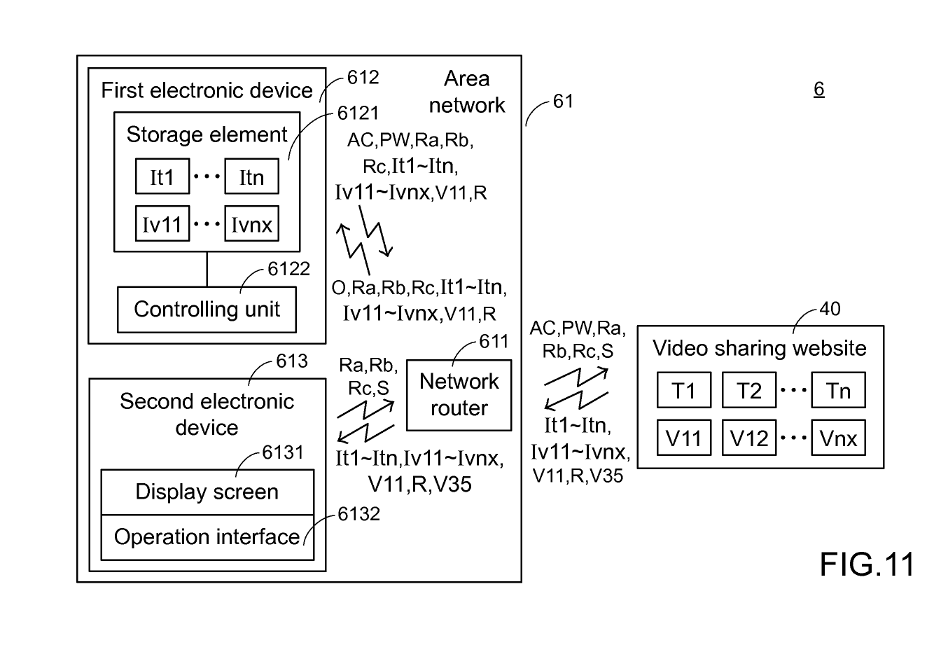

The present invention further provides a third embodiment, which is distinguished from the first embodiment. FIG. 11 is a schematic functional block diagram illustrating a video media playing system according to a third embodiment of the present invention. Please refer to FIGS. 5 and 11. The video media playing system 6 comprises a video sharing website 40 and an area network 61. The configurations and functions of the video sharing website 40 are identical to those of the video sharing website of the first embodiment, and are not redundantly described herein. The area network 61 comprises a network router 611, a first electronic device 612 and a second electronic device 613. The first electronic device 612 comprises a storage element 6121 and a controlling unit 6122. The operations of the network router 611 and the second electronic device 613 are similar to those of the first embodiment, and are not redundantly described herein. In comparison with the first embodiment, the following two aspects are distinguished. Firstly, the virtual folder Fv is a default virtual folder that is previously stored in the first electronic device 612. Before the video media data Iv11˜Iv1n are acquired by the first electronic device 612, the contents of the virtual folder Fv are void. Secondly, the operations between the first electronic device 612 and the video sharing website 40 are distinguished. In other words, the video media playing method of this embodiment is distinguished from the video media playing method of the first embodiment. The video media playing method of this embodiment will be illustrated as follows.

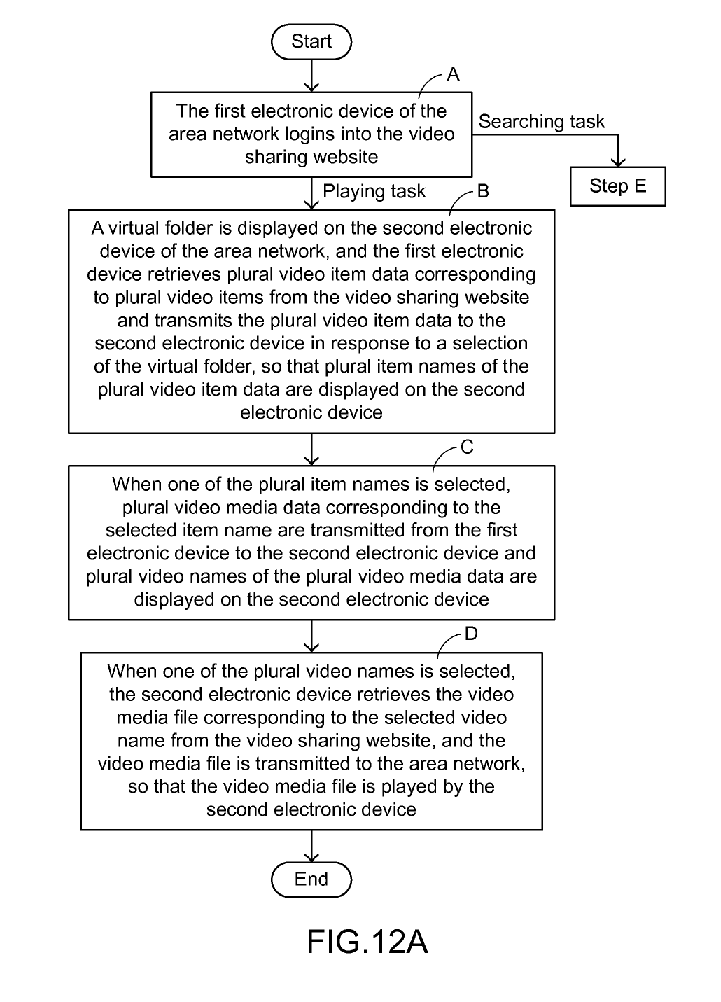

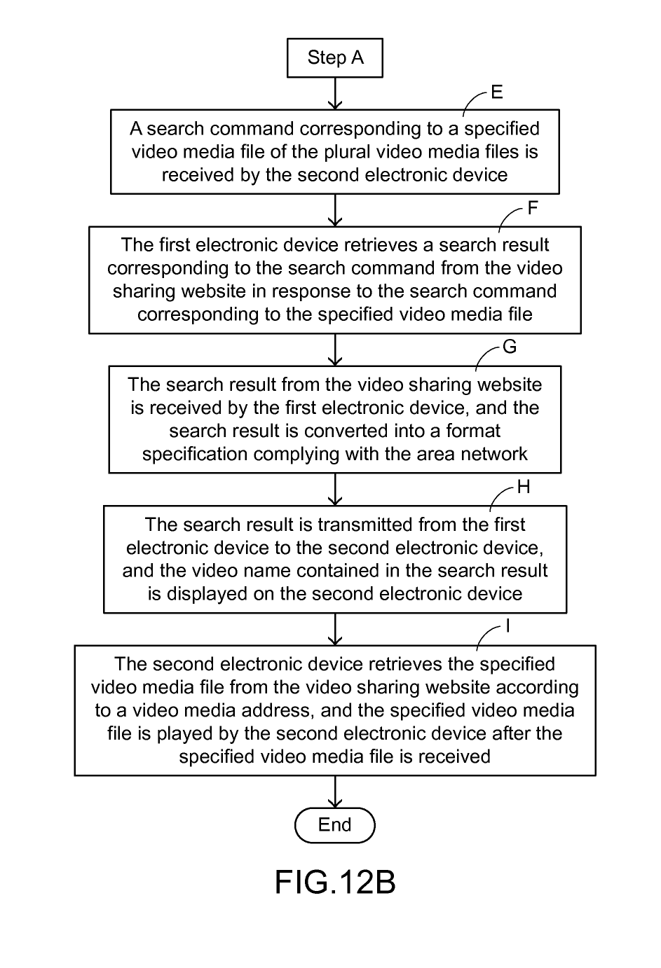

Hereinafter, a method for playing video media files of a video sharing website in an area network according to the present invention will be illustrated with reference to FIGS. 12A and 12B. FIGS. 12A and 12B schematically illustrates a flowchart of a video media playing method implemented by the video media playing system according to the third embodiment of the present invention. The video media playing method comprises the following steps.

Firstly, in a step A, the first electronic device of the area network logins into the video sharing website. In a step B, a virtual folder is displayed on the second electronic device of the area network, and the first electronic device retrieves plural video item data corresponding to plural video items from the video sharing website and transmits the plural video item data to the second electronic device in response to a selection of the virtual folder, so that plural item names of the plural video item data are displayed on the second electronic device. In a step C, when one of the plural item names is selected, plural video media data corresponding to the selected item name are transmitted from the first electronic device to the second electronic device and plural video names of the plural video media data are displayed on the second electronic device. In a step D, when one of the plural video names is selected, the second electronic device retrieves the video media file corresponding to the selected video name from the video sharing website, and the video media file is transmitted to the area network, so that the video media file is played by the second electronic device. In a step E, a search command corresponding to a specified video media file of the plural video media files is received by the second electronic device. In a step F, the first electronic device retrieves a search result corresponding to the search command from the video sharing website in response to the search command corresponding to the specified video media file. In a step G, the search result from the video sharing website is received by the first electronic device, and the search result is converted into a format specification complying with the area network. In a step H, the search result is transmitted from the first electronic device to the second electronic device, and the video name contained in the search result is displayed on the second electronic device. In a step I, the second electronic device retrieves the specified video media file from the video sharing website according to a video media address, and the specified video media file is played by the second electronic device after the specified video media file is received.

The procedures of the step A of the video media playing method of this embodiment is identical to the procedures of the step A of the video media playing method of the first embodiment, and are not redundantly described herein.

Moreover, the step B comprises the following sub-steps B1˜B4. In the sub-step B1, the first electronic device receives a retrieve request corresponding to the virtual folder from the second electronic device. In the sub-step B2, the first electronic device retrieves the plural video item data corresponding to the plural video items from the video sharing website. In the sub-step B3, the first electronic device receives the plural video item data from the video sharing website and converts the plural video item data into a format specification complying with the area network. In the sub-step B4, the plural video item data are transmitted from the first electronic device to the second electronic device, and the plural item names of the plural video item data are displayed on the second electronic device.

The step C is similar to the step B. The step C comprises the following sub-steps C1˜C4. In the sub-step C1, the first electronic device receives a retrieve request corresponding to a selected item name from the second electronic device. In the sub-step C2, the first electronic device retrieves the plural video media data corresponding to the selected item name from the video sharing website. In the sub-step C3, the first electronic device receives the plural video media data from the video sharing website and converts the plural video media data into the format specification complying with the area network. In the sub-step C4, the plural video media data are transmitted from the first electronic device to the second electronic device, and plural video names of the plural video media data are displayed on the second electronic device.

The step D comprises the following sub-steps D1 and D2. In the sub-step D1, the second electronic device retrieves a video media file corresponding to the selected video name from the video sharing website according to a video media address corresponding to the selected video name of the plural video media data. In the sub-step D2, the second electronic device receives the video media file corresponding to the selected video name from the video sharing website, and the video media file is played on the second electronic device.

The steps E˜I of this embodiment are used to perform the searching task. The steps E˜I of the video media playing method of this embodiment are identical to the steps G˜K of the searching task of the first embodiment. Hereinafter, only the playing task of the video media playing method of this embodiment will be illustrated, but the searching task of the video media playing method of this embodiment will not be redundantly described herein.

The detailed procedure of the video media playing method performed by the video media playing system 6 will be illustrated as follows. Firstly, the video media playing system 6 performs the step A, so that the first electronic device 612 logins into the video sharing website 40. The procedures of the step A of the video media playing method of this embodiment is identical to the procedures of the step A of the video media playing method of the first embodiment, and are not redundantly described herein. Then, the step B is performed. When the second electronic device 613 is connected to the first electronic device 612 through network connection, the virtual folder Fv corresponding to the video sharing website 40 is displayed on the second electronic device 613. Meanwhile, the contents of the virtual folder Fv are still void. In the step B, the virtual folder Fv is selected by the user via the operation interface 6132 of the second electronic device 613. Consequently, the second electronic device 613 issues a video item retrieve request Ra to the first electronic device 612. That is, the step B1 is performed. The video item retrieve request Ra complies with the format specification of the area network 60. Since no video media data about the video sharing website 40 are stored in the storage element 6121, the video item retrieve request Ra complying with the format specification of the area network 60 is converted into the format specification of the video sharing website 40 by the first electronic device 612, and the video item retrieve request Ra is transmitted to the video sharing website 40. That is, the step B2 is performed. In response to the video item retrieve request Ra, the plural video item data It1˜Itn corresponding to the plural video items T1˜Tn are transmitted from the video sharing website 40 to the first electronic device 612, and the plural video item data It1˜Itn complying with the format specification of the video sharing website 40 are converted into the format specification of the area network 60. Then, the plural video item data It1˜Itn are temporarily stored in the storage element 6121. That is, the sub-step B3 is performed. Then, in the sub-step B4, the plural video item data It1˜Itn are transmitted from the first electronic device 612 to the second electronic device 613, so that the plural item names of the plural video item data It1˜Itn are displayed on the display screen 6131 of the second electronic device 613. Meanwhile, the step B is completed.

The following two aspects should be specially described. Firstly, like the first embodiment, the plural video item data It1˜Itn contain the plural video names corresponding to the plural video items T1˜Tn. Secondly, after the plural video item data It1˜Itn are received by the second electronic device 613, the plural video item data It1˜Itn are deleted from the storage element 6121 of the first electronic device 612. Consequently, the storage capacity of the storage element 6121 will be enhanced.

Please refer to FIGS. 11, 12 and 12B again. In the sub-step C1, an item name (e.g. “My channel”) is selected by the user via the operation interface 6132 of the second electronic device 613. Consequently, the second electronic device 613 issues a video media retrieve request Rb corresponding to the item name to the first electronic device 612. In addition, the video media retrieve request Rb is also transmitted from the first electronic device 612 to the video sharing website 40. That is, the sub-step C2 is performed. By the way, after the video media retrieve request Rb complying with the format specification of the area network 61 is received by the first electronic device 612, the video media retrieve request Rb is converted into the format specification of the video sharing website 40 by the first electronic device 612, and then the video media retrieve request Rb is transmitted to the video sharing website 40.

In the sub-step C3, the plural video media data Iv11˜Iv1n corresponding to the item name are transmitted from the video sharing website 40 to the first electronic device 612. The plural video item data It1˜Itn contain the plural video media data Iv11˜Iv1n corresponding to the video item data It1. Moreover, the plural video media data Iv11˜Iv1n complying with the format specification of the video sharing website 40 are converted into the format specification of the area network 61 by the first electronic device 612, and then the plural video media data Iv11˜Iv1n are temporarily stored in the storage element 6121. In the sub-step C4, the plural video media data Iv11˜Iv1n are transmitted from the first electronic device 612 to the second electronic device 613, and the plural video names corresponding to the plural video media data Iv11˜Iv1n are displayed on the display screen 6131 of the second electronic device 613. After the plural video media data Iv11˜Iv1n are received by the second electronic device 613, the plural video media data Iv11˜Iv1n are deleted from the storage element 6121 of the first electronic device 612.

Next, the step D is performed. The user may select a video name (e.g. BrunoMars_MarryYou.AVI) via the operation interface 6132 of the second electronic device 613. Consequently, the second electronic device 613 is connected to the video sharing website 40 through network connection according to a video media address L11 corresponding to the video name of the video media data Iv11, and a video media retrieve request Rc corresponding to the video name is transmitted from the second electronic device 613 to the video sharing website 40. That is, the sub-step D1 is performed. In response to the video media retrieve request Rc, the video media file V11 is transmitted from the video sharing website 40 to the second electronic device 613, and the video media file V11 is played by the second electronic device 613. That is, the sub-step D2 is performed. The procedures of playing the video media files V21˜Vnx corresponding to the video items T2˜Tn are similar to the above procedures, and are not redundantly described herein.

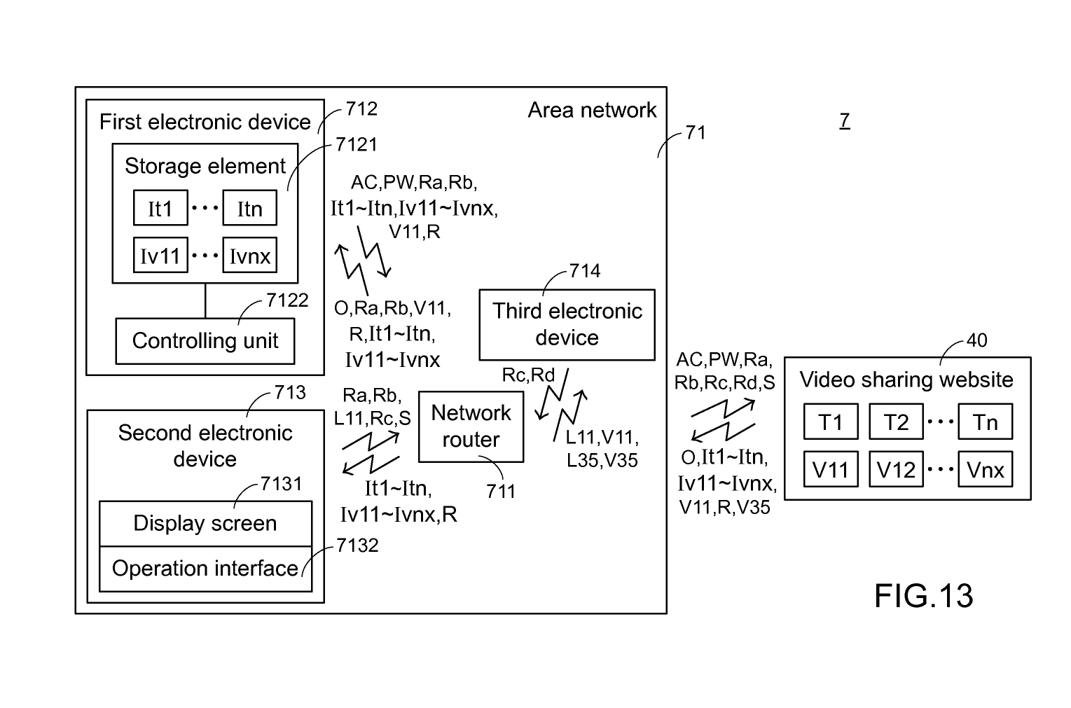

The present invention further provides a fourth embodiment, which is distinguished from the third embodiment. FIG. 13 is a schematic functional block diagram illustrating a video media playing system according to a fourth embodiment of the present invention. Please refer to FIGS. 5 and 13. The video media playing system 7 comprises a video sharing website 40 and an area network 71. The configurations and functions of the video sharing website 40 are identical to those of the video sharing website of the first embodiment, and are not redundantly described herein. As shown in FIG. 13, the area network 71 comprises a network router 711, a first electronic device 712, a second electronic device 713, and a third electronic device 714. The first electronic device 712 comprises a storage element 7121 and a controlling unit 7122. The second electronic device 713 comprises a display screen 7131 and an operation interface 7132. The third electronic device 714 is connected to the network router 711 through network connection. Moreover, the third electronic device 714 is connected to the second electronic device 713, the first electronic device 712 and the video sharing website 40 via the network router 711 through network connection. In this embodiment, the second electronic device 713 is an active control device such as a digital media controller, and the second electronic device 713 does not have the function of playing the video media files. Moreover, the third electronic device 714 is a digital media renderer for playing the video media files.

The operations of the network router 711, the first electronic device 712 and the video sharing website 40 are similar to those of the third embodiment, and are not redundantly described herein. In comparison with the third embodiment, the operations between the second electronic device 713 and the third electronic device 714 are distinguished. In other words, the steps A˜C of the video media playing method of the third embodiment are also implemented by the video media playing system 7 of this embodiment, but the step D to be implemented by the video media playing system 7 is distinguished. In the step D, when the video name corresponding to the video media data Iv11 is selected, the video media file V11 is transmitted from the video sharing website 40 to the area network 71. Consequently, the video media file V11 is played by third electronic device 714 of the area network 71.

The detailed procedures of the step D of this embodiment will be illustrated as follows. The step D comprises the following sub-steps D3˜D5. In the sub-step D3, a video media address corresponding to the selected video name of the plural video media data is transmitted from the second electronic device to the third electronic device. In the sub-step D4, the third electronic device retrieves the video media file corresponding to the selected video name from the video sharing website according to the video media address. In the sub-step D5, the video media file corresponding to the selected video name is transmitted from the video sharing website to the third electronic device, and the video media file is played by the third electronic device.

After the steps A˜C of the video media playing method of the third embodiment are implemented by the video media playing system 7, the following procedures are performed. In the sub-step D3, the video name corresponding to the video media data Iv11 is selected by the user via the operation interface 7132 of the second electronic device 713. Consequently, a video media address L11 corresponding to the video name is transmitted from the second electronic device 713 to the third electronic device 714. The third electronic device 714 is connected to the video sharing website 40 through network connection according to the video media address L11, and a video media retrieve request Rc corresponding to the video media file V11 is transmitted from the third electronic device 714 to the video sharing website 40. That is, the sub-step D4 is performed. In response to the video media retrieve request Rc, the video media file V11 is transmitted from the video sharing website 40 to the third electronic device 714, and the video media file V11 is played by the third electronic device 714. That is, the sub-step D5 is performed.

By the video media playing method of this embodiment, the plural video media files V11˜Vnx of the video sharing website 40 may be collaboratively watched by the user and other users through the third electronic device 714.

The detailed procedure of the searching task of the video media playing method performed by the video media playing system 7 will be illustrated as follows. After the step A is performed by the video media playing system 7, the user may search a desired video media file from the video sharing website 40. For example, if the user wants to search the video media file V35 from the video sharing website 40, the user has to input the corresponding search keyword into the operation interface 7132 of the second electronic device 713. Consequently, a search command S containing the above keyword is transmitted from the second electronic device 713 to the first electronic device 712. That is, the step E is performed. The search command S corresponding to the video media file V35 complies with the format specification of the area network 71. That is, the search command S complies with the DLNA protocol. After the search command S corresponding to the video media file V35 is received by the first electronic device 712, the first electronic device 712 retrieves a search result corresponding to the search command S from the video sharing website 40 in response to the search command S. That is, the step F is performed. Consequently, after the keyword is searched by the video sharing website 40, a search result R is obtained. The search result R contains the video media data Iv35 corresponding to the video media file V35. In addition, the search result R complies with the format specification of the video sharing website 40. After the search result R is obtained, the search result R is transmitted from the video sharing website 40 to the first electronic device 712.

In the step G, the search result R from the video sharing website 40 is received by the first electronic device 712, and the search result R is converted into the format specification of the area network 71. That is, the search result R complies with the DLNA protocol. Next, in the step H, the search result R is transmitted from the first electronic device 712 to the second electronic device 713, and the video name of the video media data Iv35 that is contained in the search result R is displayed on the second electronic device 713. The user may select the video name corresponding to the video media file V35 through the second electronic device 713. The video media data Iv35 also contains the video media address L35 corresponding to the video media file V35. Consequently, the video media address L35 may be transmitted from the second electronic device 713 to the third electronic device 714. According to the video media address L35, a video media retrieve request Rd is transmitted from the third electronic device 714 to the video sharing website 40. After the video media file V35 from the video sharing website 40 is received by the third electronic device 714, the video media file V35 is played by the third electronic device 714. That is, the step I is performed. Meanwhile, the searching task of the video media playing method of the present invention is completed. In other words, the video media file to be watched may be acquired by performing the playing task or the searching task of the video media playing method.

Moreover, in addition to the use of the digital media player to play the video media file, the video media playing system of the present invention may use the digital media renderer to play the video media file. Consequently, the plural video media files of the video sharing website may be collaboratively browsed by plural users.

From the above descriptions, the present invention provides a video media playing system and a video media playing method for playing plural video media files of a video sharing website in an area network. After a digital media server logins into the video sharing website and the digital media server acts as the bridge between the area network and the video sharing website, the plural video media files of the video sharing website are transmitted to a digital media renderer or a digital media player. Consequently, the plural video media files are played by the digital media renderer or the digital media player, and the operating procedures are simplified. In case that the plural video media files are played by the digital media renderer, the plural video media files may be collaboratively viewed by many users.

Moreover, after the digital media server logins into the video sharing website through network connection, plural video item data and plural video media data corresponding to the video sharing website are stored in the digital media server. Consequently, when the user intends to browse the video names or other video media data of plural video media files of the video sharing website, the data transmission speed is increased and the waiting time is shortened by simply establishing the communication between the digital media server and the active control device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A video media playing method for playing video media files of a video sharing website in an area network, the video media playing method comprising steps of:
(A) allowing a first electronic device of the area network to login into the video sharing website according to an account and a password corresponding to the video sharing website, wherein a virtual folder is previously stored in the first electronic device, and the video sharing website contains plural video items, wherein each of the plural video items contains plural video media files;
(B) displaying the virtual folder on a second electronic device of the area network, and selecting the virtual folder, wherein when the virtual folder is selected, the first electronic device retrieves plural video item data corresponding to the plural video items from the video sharing website and transmits the plural video item data to the second electronic device, wherein the plural video item data contain plural item names and are displayed on the second electronic device;
(C) selecting one of the plural item names, which are displayed on the second electronic device, wherein when the item name is selected, the first electronic device retrieves plural video media data corresponding to the selected item name from the video sharing website and transmits the plural video media data to the second electronic device, wherein the plural video media data correspond to plural video media files in the video item with the selected item name, and plural video names of the plural video media files are displayed on the second electronic device; and
(D) selecting one of the plural video names, which are displayed on the second electronic device, wherein when the video name is selected, the video media file corresponding to the selected video name is transmitted from the video sharing website to the second electronic device or a third electronic device of the area network, so that the video media file is played by the second electronic device or the third electronic device.

2. The video media playing method according to claim 1, wherein the step (A) comprises sub-steps of:
(A1) the first electronic device receiving the account and the password from a login interface;
(A2) allowing the first electronic device to be connected to the video sharing website through network connection, and transmitting the account and the password from the first electronic device to the video sharing website;
(A3) selectively allowing the first electronic device to login into the video sharing website or transmitting the account and the password to the video sharing website again according to an authentication result from the video sharing website and corresponding to the account and the password;
(A4) if the authentication result indicates that the account and the password are authenticated, allowing the first electronic device to receive an open authority information from the video sharing website and allowing the first electronic device to login into the video sharing website according to the open authority information; and
(A5) if the authentication result indicates that the account and the password are not authenticated, allowing the first electronic device to receive an authentication error message from the video sharing website, and transmitting the account and the password from the first electronic device to the video sharing website again.

3. The video media playing method according to claim 1, wherein the step (B) comprises sub-steps of:
(B1) when the virtual folder is selected, the first electronic device receiving a retrieve request corresponding to the virtual folder from the second electronic device, wherein the retrieve request corresponding to the virtual folder complies with a format specification of the area network;
(B2) the first electronic device retrieving the plural video item data corresponding to the plural video items from the video sharing website, wherein the plural video item data complies with a format specification of the video sharing website;
(B3) the first electronic device receiving the plural video item data from the video sharing website and converting the plural video item data into the format specification of the area network; and
(B4) transmitting the plural video item data from the first electronic device to the second electronic device, and displaying the plural item names of the plural video item data on the second electronic device, wherein the first electronic device is a digital media server according to a DLNA protocol, and the second electronic device is a digital media player or a digital media controller according to the DLNA protocol.

4. The video media playing method according to claim 1, wherein the step (C) comprises sub-steps of:
(C1) the first electronic device receiving a retrieve request corresponding to the selected item name from the second electronic device, wherein the retrieve request corresponding to the selected item name complies with a format specification of the area network;
(C2) the first electronic device retrieving the plural video media data corresponding to the selected item name from the video sharing website, wherein the plural video media data complies with a format specification of the video sharing website;
(C3) the first electronic device receiving the plural video media data from the video sharing website and converting the plural video media data into the format specification of the area network; and
(C4) transmitting the plural video media data from the first electronic device to the second electronic device, and displaying the plural video names of the plural video media data on the second electronic device.

5. The video media playing method according to claim 1, wherein the step (D) comprises sub-steps of:
(D1) the second electronic device retrieving the video media file corresponding to the selected video name from the video sharing website according to a video media address corresponding to the selected video name of the plural video media data; and
(D2) the second electronic device receiving the video media file corresponding to the selected video name from the video sharing website, so that the video media file is played by the second electronic device, wherein the first electronic device is a digital media server according to a DLNA protocol, and the second electronic device is a digital media player or a digital media controller according to the DLNA protocol.

6. The video media playing method according to claim 1, wherein the step (D) comprises sub-steps of:
(D3) transmitting a video media address corresponding to the selected video name of the plural video media data from the second electronic device to the third electronic device;
(D4) the third electronic device retrieving the video media file corresponding to the selected video name from the video sharing website according to the video media address; and
(D5) the third electronic device receiving the video media file corresponding to the selected video name from the video sharing website, so that the video media file is played by the third electronic device, wherein the third electronic device is a digital media renderer according to a DLNA protocol.

7. The video media playing method according to claim 1, wherein after the step (A), the video media playing method further comprises steps of:
(E) the second electronic device receiving a search command corresponding to a specified video media file of the plural video media files, wherein the search command corresponding to the specified video media file complies with a format specification of the area network;
(F) the first electronic device retrieving a search result corresponding to the search command from the video sharing website in response to the search command corresponding to the specified video media file, wherein the search result complies with a format specification of the video sharing website, wherein the search result contains the video media data corresponding to the specified video media file;
(G) the first electronic device receiving the search result from the video sharing website, and converting the search result into the format specification of the area network;
(H) transmitting the search result from the first electronic device to the second electronic device, so that the video name of the video media data contained in the search result is displayed on the second electronic device, wherein the video media data further contains a video media address corresponding to the specified video media file; and
(I) the second electronic device or the third electronic device retrieving the specified video media file from the video sharing website according to the video media address, so that the specified video media file is played by the second electronic device or the third electronic device after the specified video media file is received.

8. A video media playing method for playing video media files of a video sharing website in an area network, the video media playing method comprising steps of:
(A) allowing a first electronic device of the area network to login into the video sharing website according to an account and a password corresponding to the video sharing website, wherein the video sharing website contains plural video items, wherein each of the plural video items contains plural video media files;
(B) after the first electronic device logins into the video sharing website, the first electronic device retrieving plural video item data corresponding to the plural video items and plural video media data corresponding to the plural video media files from the video sharing website, wherein the plural video item data contain plural item names corresponding to the plural video items, and each of the plural video media data contains plural video names corresponding to the plural video media files;
(C) storing plural video item data and the plural video media data into the first electronic device, and correlating the video sharing website with a virtual folder of the first electronic device;
(D) displaying the virtual folder on a second electronic device of the area network, and selecting the virtual folder, wherein when the virtual folder is selected, the plural video item data corresponding to the plural video items are transmitted from the first electronic device to the second electronic device, wherein the plural video item data contain plural item names and are displayed on the second electronic device;
(E) selecting one of the plural item names, which are displayed on the second electronic device, wherein when the item name is selected, the first electronic device retrieves the plural video media data corresponding to the selected item name from the video sharing website and transmits the plural video media data to the second electronic device, wherein the plural video media data correspond to the plural video media files in the video item with the selected item name, and the plural video names of the plural video media files are displayed on the second electronic device; and
(F) selecting one of the plural video names, which are displayed on the second electronic device, wherein when the video name is selected, the video media file corresponding to the selected video name is transmitted from the video sharing website to the second electronic device or a third electronic device of the area network, so that the video media file is played by the second electronic device or the third electronic device.

9. The video media playing method according to claim 8, wherein the step (A) comprises sub-steps of:
(A1) the first electronic device receiving the account and the password from a login interface;
(A2) allowing the first electronic device to be connected to the video sharing website through network connection, and transmitting the account and the password from the first electronic device to the video sharing website;
(A3) selectively allowing the first electronic device to login into the video sharing website or transmitting the account and the password to the video sharing website again according to an authentication result from the video sharing website and corresponding to the account and the password;
(A4) if the authentication result indicates that the account and the password are authenticated, allowing the first electronic device to receive an open authority information from the video sharing website and allowing the first electronic device to login into the video sharing website according to the open authority information; and
(A5) if the authentication result indicates that the account and the password are not authenticated, allowing the first electronic device to receive an authentication error message from the video sharing website, and transmitting the account and the password from the first electronic device to the video sharing website again.

10. The video media playing method according to claim 8, wherein the step (C) comprises sub-steps of:
(C1) the first electronic device acquiring plural item identities, plural item kinships and plural item types corresponding to the plural video items and plural video identities, plural video kinships and plural video types corresponding to the plural video media files according to the plural video item data and the plural video media data, wherein after the plural video item data and the plural video media data from the video sharing website are received by the first electronic device, the plural video item data and the plural video media data are converted into a format specification of the area network;
(C2) writing the plural item identities, the plural item kinships, the plural item types, the plural video identities, the plural video kinships and the plural video types into a metadata corresponding to the video sharing website by the first electronic device, and storing the metadata into the first electronic device;
(C3) creating the virtual folder in the first electronic device; and
(C4) correlating the video sharing website with the virtual folder according to the plural item identities, the plural item kinships, the plural item types, the plural video identities, the plural video kinships and the plural video types.

11. The video media playing method according to claim 8, wherein the step (F) comprises sub-steps of:
(F1) the second electronic device retrieving the video media file corresponding to the selected video name from the video sharing website according to a video media address corresponding to the selected video name of the plural video media data; and
(F2) the second electronic device receiving the video media file corresponding to the selected video name from the video sharing website, so that the video media file is played by the second electronic device, wherein the first electronic device is a digital media server according to a DLNA protocol, and the second electronic device is a digital media player or a digital media controller according to the DLNA protocol.

12. The video media playing method according to claim 8, wherein the step (D) comprises sub-steps of:
(F3) transmitting a video media address corresponding to the selected video name of the plural video media data from the second electronic device to the third electronic device;
(F4) the third electronic device retrieving the video media file corresponding to the selected video name from the video sharing website according to the video media address; and
(F5) the third electronic device receiving the video media file corresponding to the selected video name from the video sharing website, so that the video media file is played by the third electronic device, wherein the third electronic device is a digital media renderer according to a DLNA protocol.

13. The video media playing method according to claim 8, wherein after the step (A), the video media playing method further comprises steps of:
(G) the second electronic device receiving a search command corresponding to a specified video media file of the plural video media files, wherein the search command corresponding to the specified video media file complies with a format specification of the area network;
(H) the first electronic device retrieving a search result corresponding to the search command from the video sharing website in response to the search command corresponding to the specified video media file, wherein the search result complies with a format specification of the video sharing website, wherein the search result contains the video media data corresponding to the specified video media file;
(I) the first electronic device receiving the search result from the video sharing website, and converting the search result into the format specification of the area network;
(J) transmitting the search result from the first electronic device to the second electronic device, so that the video name of the video media data contained in the search result is displayed on the second electronic device, wherein the video media data further contains a video media address corresponding to the specified video media file; and
(K) the second electronic device or the third electronic device retrieving the specified video media file from the video sharing website according to the video media address, so that the specified video media file is played by the second electronic device or the third electronic device after the specified video media file is received.

14. A video media playing system, comprising:
a video sharing website containing plural video items, wherein each of the plural video items contains plural video media files, wherein the video sharing website outputs plural video item data corresponding to the plural video items and plural video media data corresponding to the plural video media files, wherein each of the plural video item data contains an item name of the corresponding video item, and each of the plural video media data contains a video name of the corresponding video media file; and
an area network connected to the video sharing website through network connection, wherein the area network comprises:
a network router connected to the video sharing website through network connection, and providing a network connection function;
a digital media server connected to the network router through network connection and connected to the video sharing website via the network router through network connection, wherein the digital media server logins into the video sharing website according to an account and a password corresponding to the video sharing website, or the digital media server receives the plural video item data and the plural video media data and outputs the plural video item data and the plural video media data; and
an active control device connected to the network router through network connection and connected to the digital media server and the video sharing website via the network router through network connection, wherein the plural item names and the plural video names are selective through the active control device, wherein when one of the plural video names is selected, the active control device retrieves the video media file corresponding to the video name from the video sharing website, and the video media file is transmitted from the video sharing website to the area network, so that the video media file is acquired and played by one of the active control device and a digital media renderer of the area network.

15. The video media playing system according to claim 14, wherein the account and the password corresponding to the video sharing website are received by the digital media server through a login interface, wherein the login interface comprises and input account field and an input password field, wherein the account is keyed into the input account field, and the password is keyed into the input password field, wherein after the account and the password are transmitted from the login interface to the video sharing website, the video sharing website judges whether the account and the password are authenticated by comparing the account with a predetermined account and comparing the password with a predetermined password, wherein if the account complies with the predetermined account and the password complies with the predetermined password, the video sharing website judges that the account and the password are authenticated, so that the digital media server logins into the video sharing website.

16. The video media playing system according to claim 14, wherein the digital media server comprises:
a storage element disposed within the digital media server, wherein the plural video item data and the plural video media data are stored in the storage element; and
a controlling unit connected to the storage element, wherein the digital media server logins into the video sharing website according to the account and the password after the account and the password corresponding to the video sharing website are received by the controlling unit, or a virtual folder corresponding to the video sharing website is created by the controlling unit according to plural item identities, plural item kinships and plural item types corresponding to the plural video items and plural video identities, plural video kinships and plural video types corresponding to the plural video media files, wherein after the plural video item data and the plural video media data are received by the digital media server, the plural item identities, the plural item kinships, the plural item types, the plural video identities, the plural video kinships and the plural video types into a metadata corresponding to the video sharing website are written into a metadata corresponding to the video sharing website by the controlling unit, and the virtual folder is correlated with the video sharing website by the controlling unit according to the plural item identities, the plural item kinships, the plural item types, the plural video identities, the plural video kinships and the plural video types of the metadata.

17. The video media playing system according to claim 16, wherein when one of the plural video names is selected through the active control device, the active control device retrieves the video media file corresponding to the selected video name from the video sharing website according to a video media address corresponding to the selected video name of the plural video media data, so that the video media file is transmitted from the video sharing website to the active control device and played by the active control device; or when one of the plural video names displayed on the active control device is selected, the video media address corresponding to the selected video name is transmitted from the active control device to the digital media renderer, and the digital media renderer retrieves the video media file corresponding to the selected video name from the video sharing website according to the video media address, so that the video media file is transmitted from the video sharing website to the digital media renderer and played by the digital media renderer, wherein the active control device is a digital media player or a digital media controller, the area network complies with a DLNA protocol, and the network router complies with a UPnP protocol.

18. The video media playing system according to claim 14, wherein the digital media server comprises:
a storage element disposed within the digital media server, wherein the plural video item data and the plural video media data are temporarily stored in the storage element; and
a controlling unit connected to the storage element, wherein the digital media server logins into the video sharing website according to the account and the password after the account and the password corresponding to the video sharing website are received by the controlling unit, or the plural video item data and the plural video media data in the storage element are deleted by the controlling unit after the plural video item data and the plural video media data from the digital media server are received by the active control device.

19. The video media playing system according to claim 18, wherein when one of the plural video names is selected through the active control device, the active control device retrieves the video media file corresponding to the selected video name from the video sharing website according to a video media address corresponding to the selected video name of the plural video media data, so that the video media file is transmitted from the video sharing website to the active control device and played by the active control device; or when one of the plural video names displayed on the active control device is selected, the video media address corresponding to the selected video name is transmitted from the active control device to the digital media renderer, and the digital media renderer retrieves the video media file corresponding to the selected video name from the video sharing website according to the video media address, so that the video media file is transmitted from the video sharing website to the digital media renderer and played by the digital media renderer, wherein the active control device is a digital media player or a digital media controller, the area network complies with a DLNA protocol, and the network router complies with a UPnP protocol.
